(19) United States
(12) Patent Application Publication
(10) Pub. No.: US 2017/0344916 A1
(43) Pub. Date: Nov. 30, 2017

(54) SUPPORTING ANALYSIS BASED ON WORKFLOW

(71) Applicant: INTERNATIONAL BUSINESS MACHINES CORPORATION, Armonk, NY (US)

(72) Inventors: Harumitsu Fujii, Tokyo (JP); Yuto Fukui, Tokyo (JP); Sayaka Furukawa, Tokyo (JP)

(21) Appl. No.: 15/168,312

(22) Filed: May 31, 2016

(51) Int. Cl. G06Q 10/06; G06T 11/20

(52) U.S. Cl. CPC G06Q 10/0633; G06T 11/206

(57) ABSTRACT

A computer-implemented method for supporting analysis based on a workflow, includes: obtaining a non-timeline-based workflow including a first process and a second process to that is executed after the first process; and outputting a timeline-based workflow including the first process arranged at a first position corresponding to a first time and the second process arranged at a second position corresponding to a second time after the first time.

### BACKGROUND

The present invention relates generally to supporting analysis based on a workflow.

Various techniques may be used to support analysis based on a workflow.

### SUMMARY

According to an embodiment of the present invention, there is provided a computer-implemented method for supporting analysis based on a workflow. The method includes obtaining a non-timeline-based workflow including a first process and a second process that is executed after the first process. The method further includes outputting a timeline-based workflow including the first process arranged at a first position corresponding to a first time and the second process arranged at a second position corresponding to a second time after the first time.

According to another embodiment of the present invention, there is provided an apparatus for supporting analysis based on a workflow. The apparatus includes a processor and a memory coupled to the processor. The memory includes program instructions. The program instructions are executable by the processor to cause the processor to obtain a non-timeline-based workflow including a first process and a second process that is executed after the first process. The program instructions are executable by the processor to further cause the processor to output a timeline-based workflow including the first process arranged at a first position corresponding to a first time and the second process arranged at a second position corresponding to a second time after the first time.

According to yet another embodiment of the present invention, there is provided a computer program product for supporting analysis based on a workflow. The computer program product includes a computer readable storage medium having program instructions embodied with the computer readable storage medium. The program instructions are executable by a computer to cause the computer to obtain a non-timeline-based workflow including a first process and a second process that is executed after the first process. The program instructions are executable by a computer to further cause the computer to output a timeline-based workflow including the first process arranged at a first position corresponding to a first time and the second process arranged at a second position corresponding to a second time after the first time.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a block diagram of a workflow generating device according to exemplary embodiments of the present invention.

FIG. 2 depicts an example of a free descriptive workflow used by a workflow generator according to the exemplary embodiments.

FIG. 3 depicts an example of a timeline-based workflow generated by the workflow generator according to the exemplary embodiments.

FIG. 4 depicts an example of a bucket-pipe type workflow generated by the workflow generator according to the exemplary embodiments.

FIG. 5 depicts an example of task information used by the workflow generator according to the exemplary embodiments.

FIG. 6 depicts a flowchart representing an example of an operation of the workflow generator according to the exemplary embodiments.

FIGS. 7A and 7B depict flowcharts representing an example of a flow of a workflow conversion processing.

FIG. 8 depicts an example of a combination of a bucket object and an accumulated water object arranged on a process.

FIG. 9 depicts an example of a combination of bucket objects and pipe objects arranged on one lane.

FIG. 10A depicts an example of a combination of bucket objects, pipe objects, and running water objects arranged on one lane, and FIG. 10B depicts an example of time charts indicating operating times of processes by workers within a predetermined period.

FIG. 11 depicts an example of a hardware configuration of the workflow generating device according to the exemplary embodiments.

### DETAILED DESCRIPTION

Hereinafter, exemplary embodiments of the present invention will be described in detail with reference to the attached drawings.

It is to be noted that the present invention is not limited to these exemplary embodiments to be given below and may be implemented with various modifications within the scope of the present invention. In addition, the drawings used herein are for purposes of illustration, and may not show actual dimensions.

A workflow diagram (hereinafter referred to simply as a “workflow”) includes plural processes and plural flows of tasks each from one process to another of the plural processes. Generally, each of the plural processes may be represented by a rectangle or an icon, and each of the plural flows may be represented by an arrow. This type of workflow may not show which process constitutes a bottleneck, namely a part where the tasks are accumulated.

Even if a user has specified a process constituting a bottleneck, the workflow's characteristic of being freely described may prevent the user from analyzing the bottleneck. The user cannot confirm at a glance whether the process constituting the bottleneck is within the first half or the second half of the entire workflow.

In view of this, the exemplary embodiments may generate a workflow in which each process is represented by a bucket, each flow by a pipe, and each task by water. By virtue of such representation, the exemplary embodiments may enable users to confirm accumulation states of tasks and excess or deficiency of human resources for each process.

In addition, the exemplary embodiments may convert a free descriptive workflow into a timeline-based workflow. The free descriptive workflow may be created independently of a timeline at users' discretion. In this sense, the free descriptive workflow serves as one example of a non-timeline-based workflow. The timeline-based workflow may be created by arranging the processes in a chronological order, for example, from left to right. Alternatively, the timeline-based workflow may be created further by arranging the processes separately in lanes each corresponding to one of roles sorted in order of an applicant to an approver. By virtue of the conversion, the exemplary embodiments may facilitate users to analyze a bottleneck.

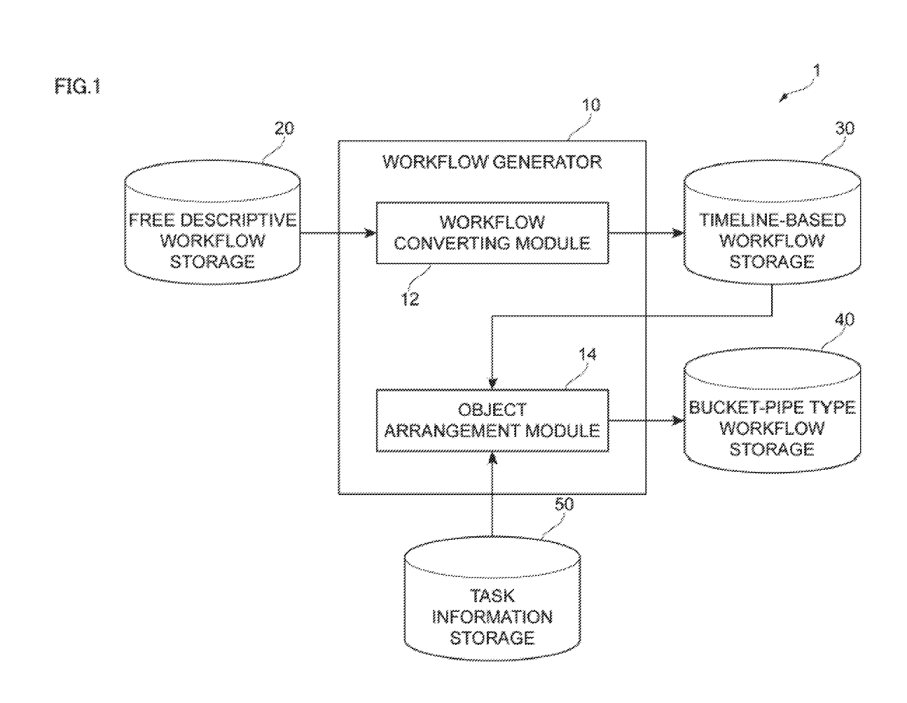

Referring to FIG. 1, there is shown a block diagram of a workflow generating device 1 to which the exemplary embodiments are applied. As shown in the figure, the workflow generating system 1 may include a workflow generator 10. In addition, the workflow generating system 1 may include a free descriptive workflow storage 20 for storing a free descriptive workflow, a timeline-based workflow storage 30 for storing a timeline-based workflow, a bucket-pipe type workflow storage 40 for storing a bucket-pipe type workflow, and a task information storage 50 for storing task information.

The workflow generator 10 may generate the timeline-based workflow based on the free descriptive workflow stored in the free descriptive workflow storage 20, and may store the timeline-based workflow in the timeline-based workflow storage 30. Further, the workflow generator 10 may generate the bucket-pipe type workflow based on the timeline-based workflow stored in the timeline-based workflow storage 30, and may store the bucket-pipe type workflow in the bucket-pipe type workflow storage 40. When generating the bucket-pipe type workflow, the workflow generator 10 may use the task information stored in the task information storage 50. Specifically, the workflow generator 10 may include a workflow converting module 12 and an object arrangement module 14.

The workflow converting module 12 may first obtain the free descriptive workflow. Next, the workflow converting module 12 may convert the free descriptive workflow into the timeline-based workflow. Subsequently, the workflow converting module 12 may output the timeline-based workflow.

The object arrangement module 14 may first obtain the timeline-based workflow. Next, the object arrangement module 14 may generate the bucket-pipe type workflow by arranging display objects (hereinafter referred to simply as “objects”) on the timeline-based workflow, using the task information. Subsequently, the object arrangement module 14 may output the bucket-pipe type workflow.

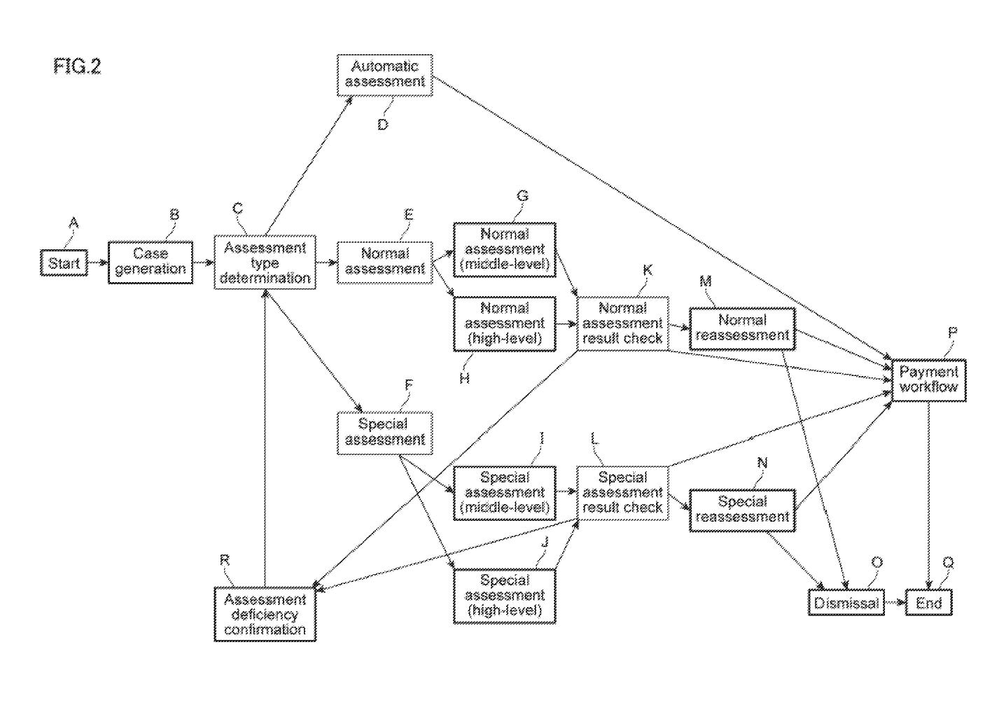

Referring to FIG. 2, there is shown an example of the free descriptive workflow stored in the free descriptive workflow storage 20. In FIG. 2, the free descriptive workflow is assumed to include plural processes each represented by a rectangle, and plural flows each represented by an arrow. The free descriptive workflow may be described using a workflow software by a user in a form free from any restrictions on arrangement positions of rectangles and arrows. In addition, the free descriptive workflow may be accompanied by control information designated by the user.

The control information may indicate the type of each of the processes. The type of each process may define whether the process is a process to be executed automatically by a computer (hereinafter referred to as an “automatic process”) or a process to be executed manually by a worker (hereinafter referred to as a “manual process”). In FIG. 2, the automatic process is represented by a thin-lined rectangle, and the manual process is represented by a thick-lined rectangle.

The control information may further indicate the type of each of the flows. The type of each flow may define whether the flow is a normal flow or a return flow. In FIG. 2, the flows from the process K to the process R, from the process L to the process R, and from the process R to the process C are return flows, and the other flows are normal flows.

The control information may further indicate authority over each of the processes. The authority may define which of plural roles is required for a worker to execute each process. The plural roles may include, for example, roles of a high-level approver, a middle-level approver, and an applicant.

The control information may furthermore indicate a priority of each of the processes. The priority may be presented as an order in which plural processes are arranged on a line corresponding to a specific time.

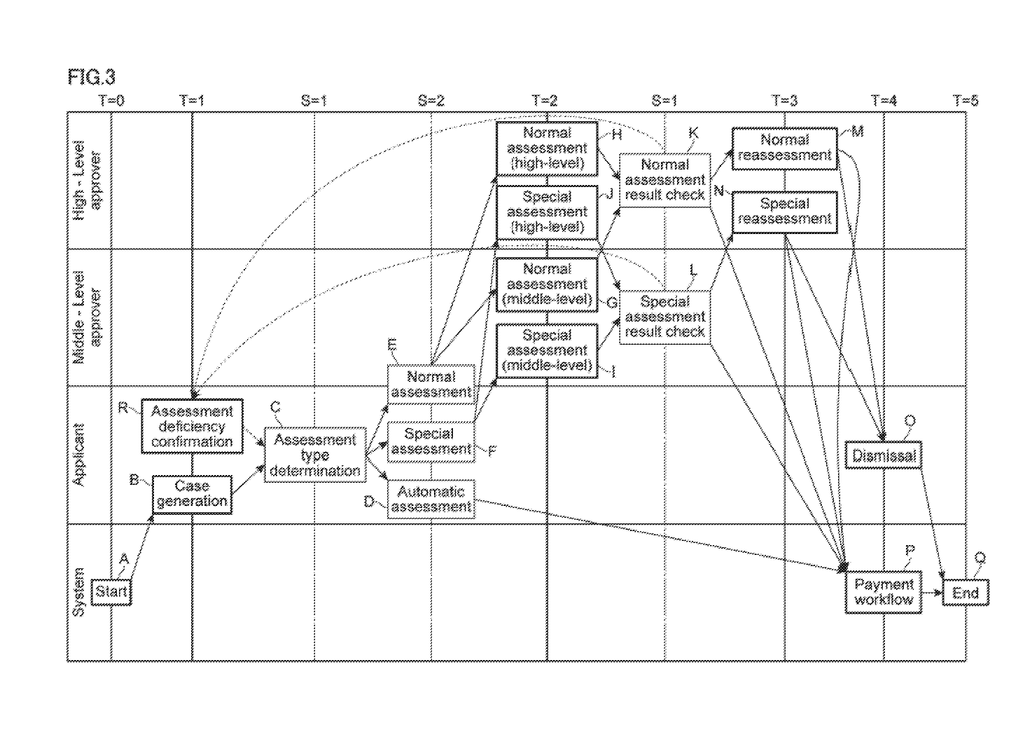

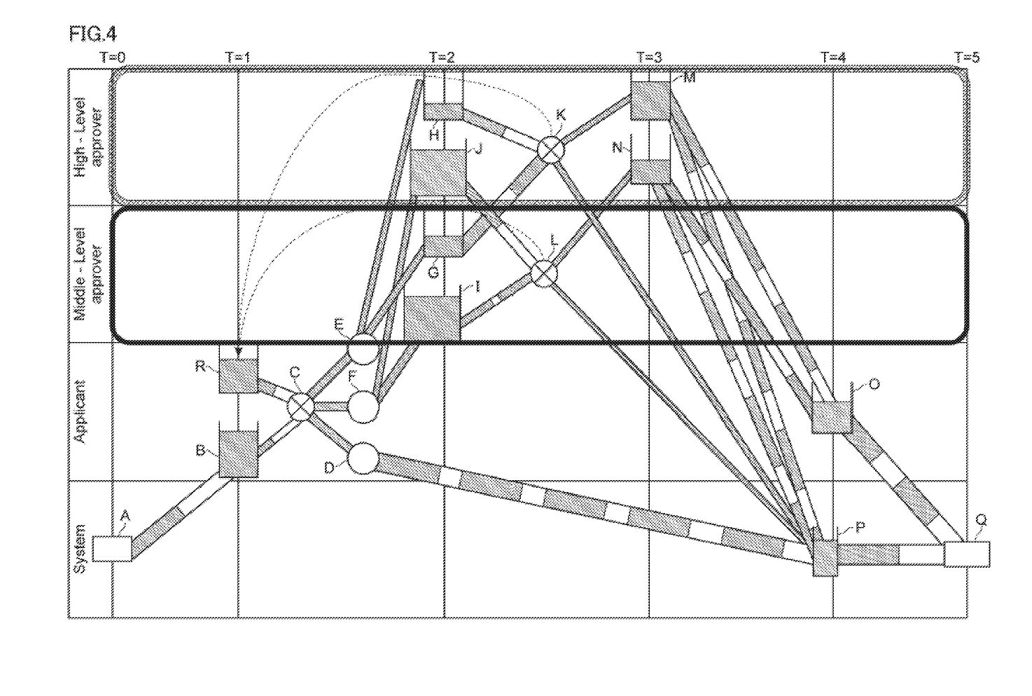

Referring to FIG. 3, there is shown an example of the timeline-based workflow stored in the timeline-based workflow storage 30. The timeline-based workflow may be generated by tailoring the free descriptive workflow of FIG. 2 based on the above control information indicating at which position within which of the plural lanes each process is to be arranged. Also in FIG. 3, the timeline-based workflow is assumed to include plural processes each represented by a rectangle, and plural flows each represented by an arrow. In addition, the automatic process is represented by a thin-lined rectangle, and the manual process is represented by a thick-lined rectangle.

As shown in FIG. 3, the timeline-based workflow may have a time axis in the horizontal direction. The time axis may be provided with two types of timing numbers.

One of the two types may be timing numbers along a timeline for the manual processes. In FIG. 3, a variable T represents this type of timing numbers. For example, the variable T is set to 1 for the process B, and set to 4 for the process P. In this sense, the process B serves as one example of a first process arranged at a position corresponding to a first time, and the process P serves as one example of a second process arranged at a position corresponding to a second time. The state in which T is set to 1 for the process B and set to 4 for the process P is one example of the state in which the second time is apart from the first time by an interval depending on a maximum number of processes from the first process to the second process.

The other of the two types may be timing numbers along a timeline for the automatic processes. In FIG. 3, a variable S represents this type of timing numbers. For example, when T is set to 1, the variable S is set to 1 for the process C, and set to 2 for each of the processes D to F. In this sense, assuming that the process B is a first process arranged at a position corresponding to a first time and any one of the processes G to J is a second process arranged at a position corresponding to a second time, each of the processes C to F serves as one example of a fourth process arranged at a position corresponding to a fourth time along a timeline for automatic processes to be executed after the first time and before the second time.

Note that, although the time axis is provided with the two types of timing numbers in the foregoing description, the time axis may be provided with one type of timing numbers.

That is, the time axis may be provided with timing numbers along a timeline for both the manual processes and the automatic processes. In this case, the variables T and S may be changed to a variable pair (T, S) to represent such timing numbers. For example, the variable pair (T, S) may be set to (1, 1) for the process C, and set to (2, 1) for each of the processes K and L. In this sense, the process C serves as one example of a first process arranged at a position corresponding to a first time, and each of the processes K and L serves as one example of a second process arranged at a position corresponding to a second time. The state in which (T, S) is set to (1, 1) for the process C and set to (2, 1) for each of the processes K and L is one example of the state in which the second time is apart from the first time by an interval depending on a maximum number of processes from the first process to the second process.

Alternatively, the time axis may be provided with timing numbers along a timeline for only the manual processes. In this case, the variables T and S may be changed to a variable T to represent such timing numbers. For example, the variable T may be set to 1 for each of the processes B to F, and set to 2 for each of the processes G to L. In this sense, each of the processes B to F serves as one example of a first process arranged at a position corresponding to a first time, and each of the processes G to L serves as one example of a second process arranged at a position corresponding to a second time.

As shown in FIG. 3, the timeline-based workflow may be separated in the vertical direction into plural lanes each corresponding to one of the plural roles. In FIG. 3, the timeline-based workflow is separated into four lanes, and the four lanes include, from the top, a lane corresponding to a high-level approver, a lane corresponding to a middle-level approver, a lane corresponding to an applicant, and a lane corresponding to a system.

Further, the timeline-based workflow may include one or more return processes and one or more return flows. In FIG. 3, the timeline-based workflow includes one return process and three return flows. For example, the process R is the one return process. In this sense, assuming that the process C is a first process arranged at a position corresponding to a first time and any one of the processes K and L is a second process arranged at a position corresponding to a second time, the process R serves as one example of a third process which is a destination of return after the second process, to be executed before the first process, and arranged at a position corresponding to a third time which is a time point from the first time to the second time. The flows from the process K to the process R, from the process L to the process R, and from the process R to the process C are the return flows.

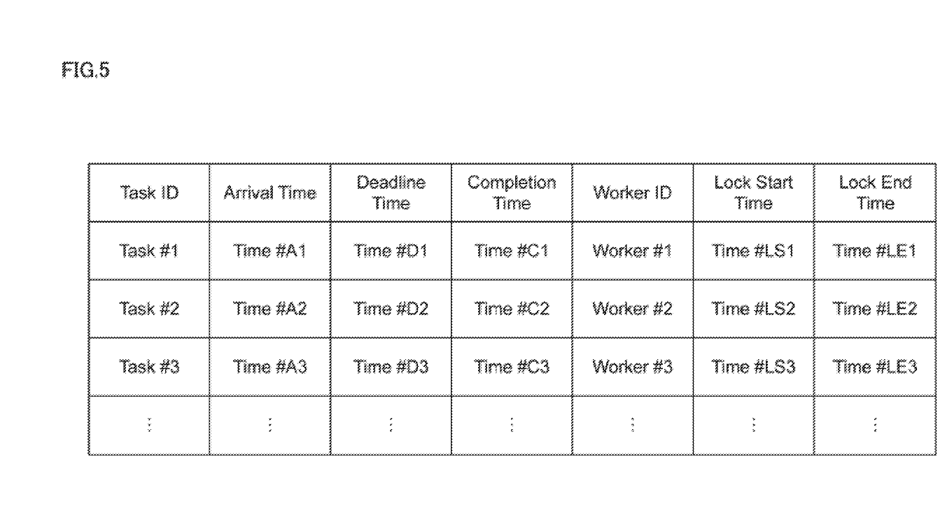

Referring to FIG. 4, there is shown an example of the bucket-pipe type workflow stored in the bucket-pipe type workflow storage 40. As shown in FIG. 4, in the bucket-pipe type workflow, an object may be used instead of a rectangle or an arrow to represent each of the plural processes or each of the plural flows on the timeline-based workflow shown in FIG. 3, although the bucket-pipe type workflow has the same layout as the timeline-based workflow. For example, an object designed after a bucket (hereinafter referred to as a “bucket object”) may be used to represent each of the plural processes, and an object designed after accumulated water (hereinafter referred to as an “accumulated water object”) may be used to represent tasks accumulated in each of the plural processes. Further, an object designed after a pipe (hereinafter referred to as a “pipe object”) may be used to represent each of the plural flows, and an object designed after running water (hereinafter referred to as a “running water object”) may be used to represent tasks running through each of the plural flows.

Referring to FIG. 5, there is shown an example of the task information stored in the task information storage 50. In FIG. 5, the task information is assumed to be a task information table, although it may be of any type. Further, the task information table may be provided for each of the plural processes. The task information table shown in FIG. 5 is assumed to be provided for corresponding one of the plural processes. As shown in FIG. 5, the task information table may contain plural records. Each of the plural records may include a task ID, an arrival time, a deadline time, a completion time, a worker ID, a lock start time, and a lock end time.

The task ID may be an identifier identifying a task managed by each record. The arrival time may be a time when the task has arrived at the corresponding process. The deadline time may be a time by when execution of the task has to be completed in the corresponding process. The completion time may be a time when execution of the task has been completed and the task has exited from the corresponding process.

The worker ID may be an identifier identifying a worker who has executed or is executing the task in the corresponding process. The lock start time may be a time when the worker starts a lock of the task in the corresponding process. The lock end time may be a time when the worker ends the lock of the task in the corresponding process.

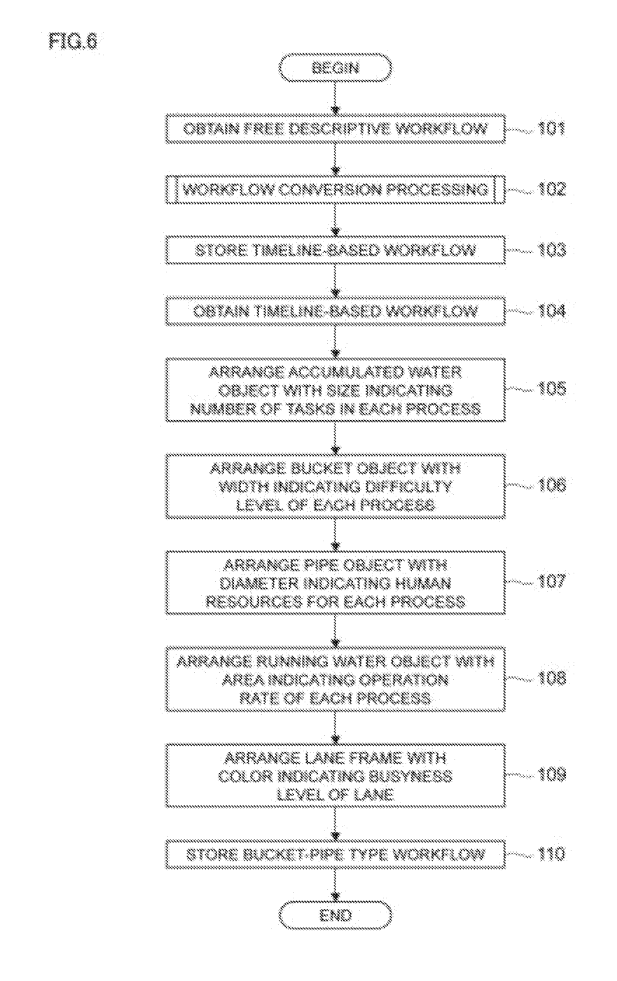

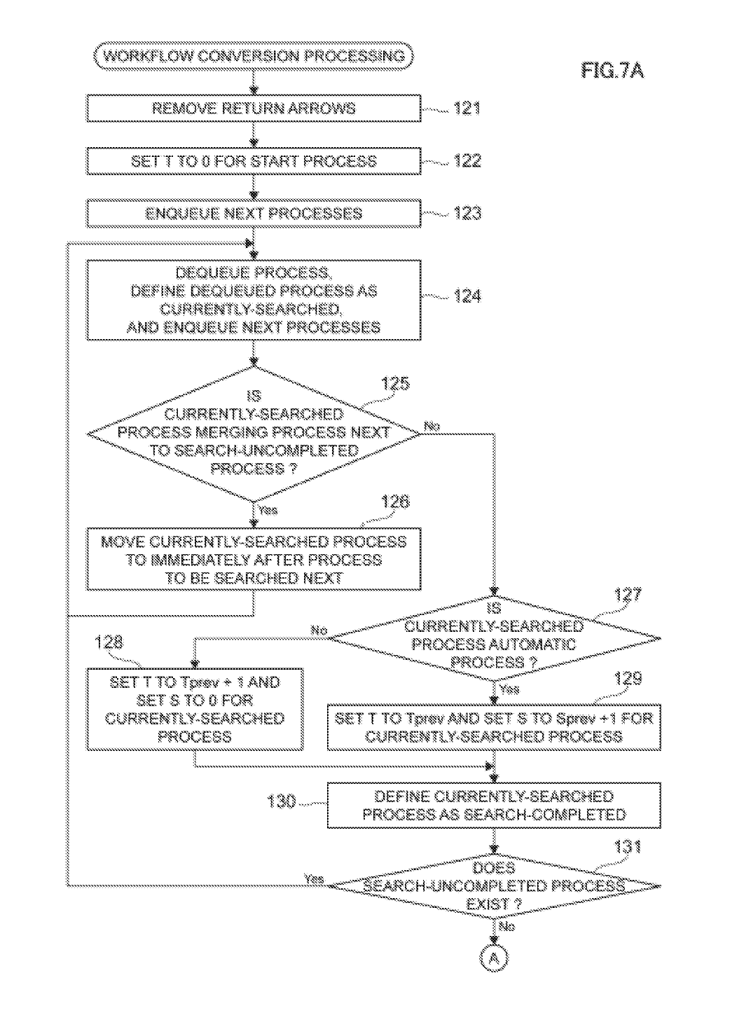

Referring to FIG. 6, there is shown a flowchart representing an example of an operation of the workflow generator 10 according to the exemplary embodiments. Note that a user is assumed to create the free descriptive workflow and stored it in the free descriptive workflow storage 20 prior to the operation of the workflow generator 10.

As shown in the figure, the workflow converting module 12 may first obtain the free descriptive workflow from the free descriptive workflow storage 20 (step 101). Then, the workflow converting module 12 may execute a workflow conversion processing to convert the free descriptive workflow into the timeline-based workflow (step 102). The details of the workflow conversion processing will be described later. Subsequently, the workflow converting module 12 may store the timeline-based workflow in the timeline-based workflow storage 30 (step 103).

Next, the object arrangement module 14 may obtain the timeline-based workflow from the timeline-based workflow storage 30 (step 104). Then, the object arrangement module 14 may generate the bucket-pipe type workflow by arranging objects on the timeline-based workflow at steps 105 to 109. At this time, one or more workers are assumed to be allocated to each of the lanes, for example, by drag-and-drop operations. The object arrangement module 14 may arrange, on each of the plural processes, an accumulated water object with a size indicating the number of tasks in the process (step 105). The object arrangement module 14 may arrange, on each of the plural processes, a bucket object with a width indicating a difficulty level of the process (step 106). The object arrangement module 14 may arrange, on a flow from each of the plural processes to another, a pipe object with a diameter indicating human resources for the process (step 107). The object arrangement module 14 may arrange, on a flow from each of the plural processes to another, a running water object with an area the ratio of which to an area of the pipe object indicates an operation rate of the process (step 108). The object arrangement module 14 may arrange, on each of the plural lanes, a lane frame with a color indicating a busyness level of the lane (step 109). If the busyness level is high, the number of the workers may be determined as being short, and if the busyness level is low, the number of the workers may be determined as being in excess. The details of each of the steps 105 to 109 will be described later.

Subsequently, the object arrangement module 14 may store the bucket-pipe type workflow in the bucket-pipe type workflow storage 40 (step 110).

Next, the details of the workflow conversion processing at step 102 will be described.

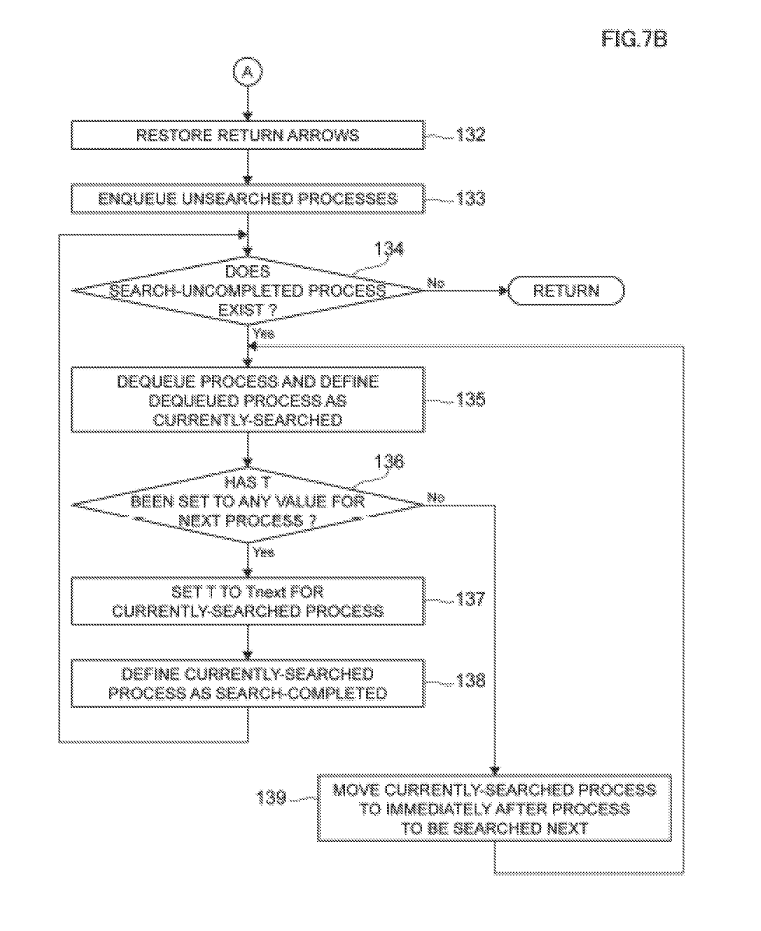

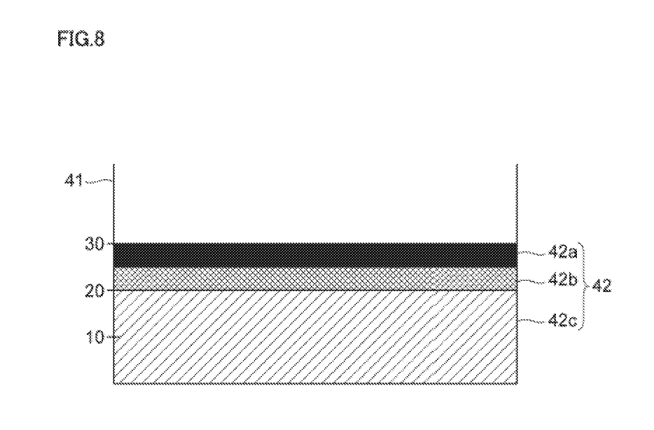

Referring to FIGS. 7A and 7B, there are shown flowcharts representing an example of a flow of the workflow conversion processing executed at step 102 of FIG. 6. In the workflow conversion processing, the workflow converting module 12 may search processes sequentially by breadth-first search from the start process, and may determine which of the timing numbers comes to correspond to each of the process. Note that a breadth-first search queue (hereinafter referred to simply as a “search queue”) is assumed to be prepared prior to the workflow conversion processing. In addition, the term “process” indicates not only a process in a workflow, but also data corresponding to a process in the search queue.

As shown in the FIG. 7A, the workflow converting module 12 may first remove all of the return arrows from the free descriptive workflow (step 121). Then, the workflow converting module 12 may set T to 0 for the start process (step 122). Subsequently, the workflow converting module 12 may enqueue the next one or more processes in the search queue (step 123). At this step, the next one or more processes may indicate one or more processes next to the start process. The workflow converting module 12 may enqueue all of the next one or more processes as one or more search-uncompleted processes.

Next, the workflow converting module 12 may dequeue a process from the search queue, define the dequeued process as a currently-searched process, and enqueue the next one or more processes in the search queue (step 124). At this step, the next one or more processes may indicate one or more processes next to the currently-searched process. The workflow converting module 12 may enqueue at least one of the next one or more processes other than one or more processes already enqueued in the search queue as at least one search-uncompleted process. Then, the workflow converting module 12 may determine whether or not the currently-searched process is a merging process next to at least one search-uncompleted process (step 125). In other words, the workflow converting module 12 may determine whether or not the currently-searched process is a merging process and any one of the processes previous to the currently-searched process is a search-uncompleted process. If the currently-searched process is a merging process next to at least one search-uncompleted process, the workflow converting module 12 may move, in the search queue, the currently-searched process to immediately after the process to be searched next (step 126). After that, the workflow converting module 12 may advance the processing to step 124.

On the contrary, assume that the currently-searched process is not a merging process next to at least one search-uncompleted process. This may include two cases. One of the two cases may be where the currently-searched process is not a merging process. The other of the two cases may be where the currently-searched process is a merging process but all of the processes previous to the currently-searched process are search-completed processes. In these two cases, the workflow converting module 12 may determine whether or not the currently-searched process is an automatic process (step 127).

If the currently-searched process is not an automatic process, the workflow converting module 12 may set T to Tprev+1 and set S to 0 for the currently-searched process (step 128). At this step, the value Tprev indicates a maximum of the values, to each of which T is set for the previous process. After that, the workflow converting module 12 may advance the processing to step 130.

On the contrary, if the currently-searched process is an automatic process, the workflow converting module 12 may set T to Tprev and set S to Sprev+1 for the currently-searched process (step 129). At this step, the value Tprev indicates a maximum of the values, to each of which T is set for the previous process, and the value Sprev indicates the value, to which S is set for the previous process. After that, the workflow converting module 12 may advance the processing to step 130.

Subsequently, the workflow converting module 12 may define the currently-searched process as a search-completed process (step 130). Then, the workflow converting module 12 may determine whether or not any search-uncompleted process exists in the search queue (step 131). If a search-uncompleted process exists in the search queue, the workflow converting module 12 may advance the processing to step 124. On the contrary, if no search-uncompleted process exists in the search queue, the workflow converting module 12 may advance the processing to step 132.

Next, as shown in the FIG. 7B, the workflow converting module 12 may restore all of the return arrows which have been removed from the free descriptive workflow (step 132). Then, the workflow converting module 12 may enqueue one or more unsearched processes in the search queue (step 133). At this step, the one or more unsearched processes may indicate one or more processes which have not been searched and at which only the return arrows point. The workflow converting module 12 may enqueue all of the one or more unsearched processes as one or more search-uncompleted processes. After that, the workflow converting module 12 may determine whether or not any search-uncompleted process exists in the search queue (step 134). If a search-uncompleted process exists in the search queue, the workflow converting module 12 may dequeue a process from the search queue and define the dequeued process as a currently-searched process (step 135). Then, the workflow converting module 12 may determine whether or not T has already been set to any value for the next process (step 136). At this step, the next process may indicate a process next to the currently-searched process. If T has already been set to any value for the next process, the workflow converting module 12 may set T to Tnext for the currently-searched process (step 137). At this step, the value Tnext indicates the value, to which T is set for the next process. Subsequently, the workflow converting module 12 may define the currently-searched process as a search-completed process (step 138). After that, the workflow converting module 12 may advance the processing to step 134.

On the contrary, if, at step 136, T has not yet been set to any value for the next process, the workflow converting module 12 may move, in the search queue, the currently-searched process to immediately after the process to be searched next (step 139). After that, the workflow converting module 12 may advance the processing to step 135.

Meanwhile, if, at step 134, no search-uncompleted process exists in the search queue, the workflow converting module 12 may return control to the flowchart of FIG. 6.

Next, the details of the processing at steps 105 and 106 will be described.

Referring to FIG. 8, there is shown an example of a combination of a bucket object 41 and an accumulated water object 42 arranged on a process. The bucket object 41 and the accumulated water object 42 serve as one example of a container-shaped display object designed after a fluid container and fluid accumulated in the fluid container.

At step 105, the object arrangement module 14 may calculate the number of tasks in the process. Specifically, the object arrangement module 14 may refer to task information corresponding to the process, specify one or more records with a completion time being blank, and regard the number of the one or more records as the number of the tasks in the process. In FIG. 8, the number of the tasks in the process is assumed to be 30, as indicated by the height of the accumulated water object 42.

Further, at step 105, the object arrangement module 14 may arrange each of portions 42a to 42c with a color depending on the degree of urgency of the deadline time. Specifically, the object arrangement module 14 may refer to task information corresponding to the process, specify a record with a completion time being blank, and regard the ratio of the difference between the current time and a deadline time in the record to the difference between an arrival time in the record and a deadline time in the record as the degree of urgency. In FIG. 8, the portion 42a is arranged with the first color to represent tasks which are overdue, the portion 42b is arranged with the second color to represent tasks for which x percent of the time from the arrival time to the deadline time has already elapsed, and the portion 42c is arranged with the third color to represent tasks other than the above tasks. Note that the value of x may be designated by a user.

Furthermore, at step 105, the object arrangement module 14 may arrange information indicating an increase or decrease of the number of the tasks in the past. Specifically, the object arrangement module 14 may refer to task information corresponding to the process, specify one or more records with an arrival time before a specific time in the past and with a completion time after the specific time, and regard the number of the one or more records as the number of the tasks at the specific time. Note that the information indicating the increase or decrease of the number of the tasks may be arranged as an animation playing back the number of the tasks in the past.

Note that, although information about the number of the tasks in the process, the degrees of urgency of the tasks, and the increase or decrease of the number of the tasks is indicated in the foregoing description, the type of information is not limited to this. For example, information about execution states of the tasks in the process may be indicated.

At step 106, the object arrangement module 14 may calculate the difficulty level of the process. The difficulty level of the process may be calculated based on the lengths of times during which the tasks in the process have been locked within a predetermined period. Specifically, the object arrangement module 14 may refer to task information corresponding to the process, specify a record with an arrival time within the predetermined period, and regard the difference between a lock start time in the record and a lock end time in the record as one of the lengths of times. For example, the width of the bucket object 41 may be larger as the average of the lengths of times becomes longer and thus the difficulty level of the process becomes higher.

Next, the details of the processing at step 107 will be described.

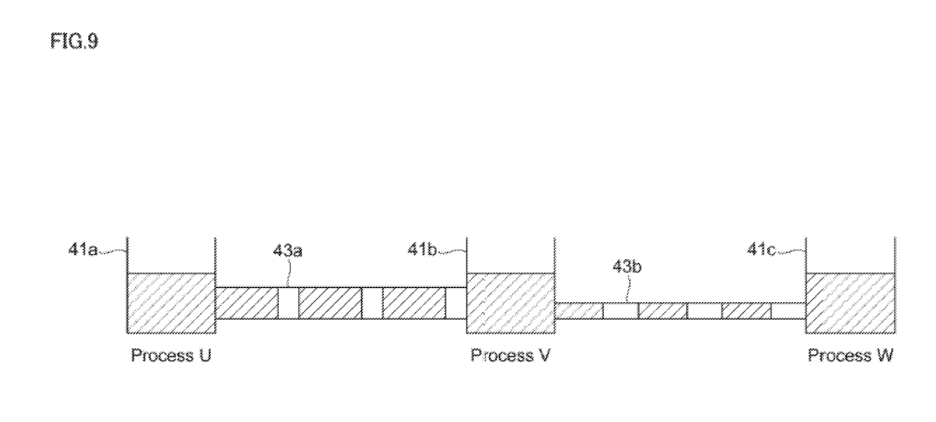

Referring to FIG. 9, there is shown an example of a combination of bucket objects 41a to 41c and pipe objects 43a and 43b arranged on one lane. In this example, the bucket objects 41a to 41c are assumed to be arranged respectively on the processes U to W, and workers #1 to #3 are assumed to be allocated to the lane. The pipe objects 43a and 43b serve as one example of a part of a channel-shaped display object designed after a fluid channel and fluid running through the fluid channel.

At step 107, the object arrangement module 14 may calculate the human resources for each process. The human resources for the process may be calculated based on the proportion of the operation in the process and skill levels of one or more workers allocated to the lane.

The proportion of the operation may be calculated based on the lengths of times during which the tasks in the process have been locked within a predetermined period. Specifically, the object arrangement module 14 may refer to task information corresponding to the process, specify a record with an arrival time within the predetermined period, and regard the difference between a lock start time in the record and a lock end time in the record as one of the lengths of times. In this example, the proportions of the operations in the processes U, V, and W are assumed to be 0.5, 0.25, and 0.25, respectively.

Each of the skill levels may be designated as an option by a user, and may be set to 1 if not designated. Alternatively, the skill level of the worker may be set dynamically based on the lengths of times during which the worker has locked tasks of a similar type. In this example, the skill levels of the workers #1, #2, and #3 are assumed to be 1.0, 0.5, and 0.1, respectively.

In this case, the human resources allocated to the process U may be calculated as follows: (1.0+0.5+0.1)*0.5=0.8, and the human resources allocated to the process V may be calculated as follows: (1.0+0.5+0.1)*0.25=0.4. Thus, the diameter of the pipe object 43b may be set half as large as that of the pipe object 43a, as shown in FIG. 9.

Next, the details of the processing at step 108 will be described.

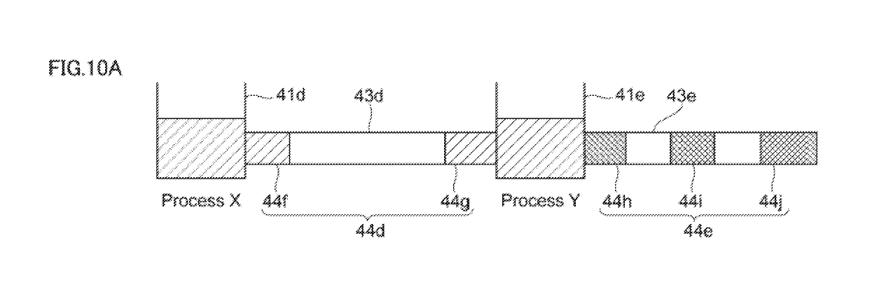

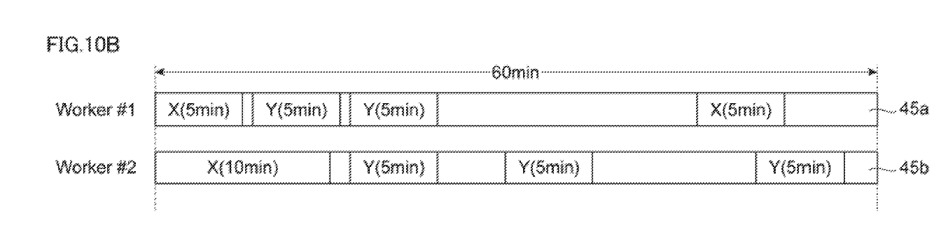

Referring to FIG. 10A, there is shown an example of a combination of bucket objects 41d and 41e, pipe objects 43d and 43e, and running water objects 44d and 44e arranged on one lane. In FIG. 10A, the bucket objects 41d and 41e are assumed to be arranged respectively on the processes X and Y. The running water objects 44d and 44e serve as one example of a part of a channel-shaped display object designed after a fluid channel and fluid running through the fluid channel.

At step 108, the object arrangement module 14 may calculate the operation rate of each process, as one example of an operation state of the process. The operation rate of the process may be calculated based on the proportion of the operation in the process and the operating times of the processes within a predetermined period.

The proportion of the operation may be calculated based on the lengths of times during which the tasks in the process have been locked within a predetermined period. Specifically, the object arrangement module 14 may refer to task information corresponding to the process, specify a record with an arrival time within the predetermined period, and regard the difference between a lock start time in the record and a lock end time in the record as one of the lengths of times. In this example, the proportions of the operations in the processes X and Y are assumed to be 0.6 and 0.4, respectively.

Referring to FIG. 10B, there is shown an example of time charts 45a and 45b indicating operating times of the processes by workers within a predetermined period. Specifically, the object arrangement module 14 may refer to all task information corresponding to all processes, specify a record with a worker ID identifying a specific worker and with a lock start time or a lock end time within the predetermined period. Then, the object arrangement module 14 may specify a process corresponding to the task information including the record, and regard the difference between a lock start time in the record and a lock end time in the record as one of the operating times of the specified process by the specific worker. In FIG. 10B, the time chart 45a indicates that a worker #1 has operated the process X for 5 minutes, the process Y for 5 minutes, the process Y for 5 minutes, and the process X for 5 minutes, within the last one hour. The time chart 45b indicates that a worker #2 has operated the process X for 10 minutes, the process Y for 5 minutes, the process Y for 5 minutes, and the process Y for 5 minutes, within the last one hour.

In this case, the operation rate of the process X may be calculated as follows: ((10/(60*0.6)+10/(60*0.6))/2=0.27, and the operation rate of the process Y may be calculated as follows: ((10/(60*0.4)+15/(60*0.4))/2=0.52. Thus, the ratio of the sum of the areas of portions 44h to 44j to the area of the pipe object 43e may be larger than the ratio of the sum of areas of portions 44f and 44g to the area of the pipe object 43d.

Further, at step 108, the object arrangement module 14 may arrange each of the portions 44f to 44j with a color depending on the operation rate of the corresponding process. For example, the portion may be arranged with the first color if the operation rate is higher than 90 percent, with the second color if the operation rate is not higher than 90 percent and not lower than 50 percent, and with the third color if the operation rate is lower than 50 percent. In FIG. 10A, the portions 44h to 44j are arranged with the second color to indicate that the operation rate is not higher than 90 percent and not lower than 50 percent.

Next, the details of the processing at step 109 will be described.

At step 109, the object arrangement module 14 may arrange each of lane frames with a color depending on the busyness level of one or more workers allocated to the corresponding lane.

For example, the lane frame may be arranged with the first color as indicated by a lane frame on the second lane from the top in FIG. 4, if the first condition is satisfied. The first condition may be that the corresponding lane includes at least one accumulated water object having a portion arranged with the first or second color at step 105, or at least one running water object having a portion arranged with the first or second color at step 108.

Further, the lane frame may be arranged with the second color as indicated by a lane frame on the first lane from the top in FIG. 4, if the second condition is satisfied. The second condition may be that operation rates of all the processes on the corresponding lane are equal to or less than a predetermined rate. Alternatively, the second condition may be that the degrees of urgency of the deadline times of the tasks in all the processes on the corresponding lane are equal to or less than a predetermined degree, or that the shortest time among the remaining times to the deadline times of the tasks in all the processes on the corresponding lane is equal to or more than x times of the average processing time of the tasks. Note that the value of x may be designated by a user.

In the foregoing description, the object arrangement module 14 is assumed to use the size or color of the accumulated water object to represent the execution states of tasks accumulated in the process, the width of the bucket object to represent the difficulty level of the process, the diameter of the pipe object to represent the human resources allocated to the process, and the area or color of the running water object to represent the operation state of the process. However, the object arrangement module 14 may use any attribute of any of the accumulated water object, the bucket object, the pipe object and the running water object to represent the aforementioned information.

Further, the object arrangement module 14 is assumed to use the color of the lane frame to represent a busyness level of at least one worker allocated to the corresponding lane. However, the object arrangement module 14 may use any attribute of the lane frame to represent the aforementioned information.

Next, an alternative exemplary embodiment will be described. In the alternative exemplary embodiment, the workflow generating device 1 may not be provided with the bucket-pipe type workflow storage 40 and the task information storage 50, and the workflow generator 10 may not be provided with the object arrangement module 14. In this case, the workflow converting module 12 may first obtain the free descriptive workflow from the free descriptive workflow storage 20. Next, the workflow converting module 12 may convert the free descriptive workflow into the timeline-based workflow. Subsequently, the workflow converting module 12 may store the timeline-based workflow in the timeline-based workflow storage 30. Alternatively, the workflow converting module 12 may display the timeline-based workflow without storing the timeline-based workflow in the timeline-based workflow storage 30.

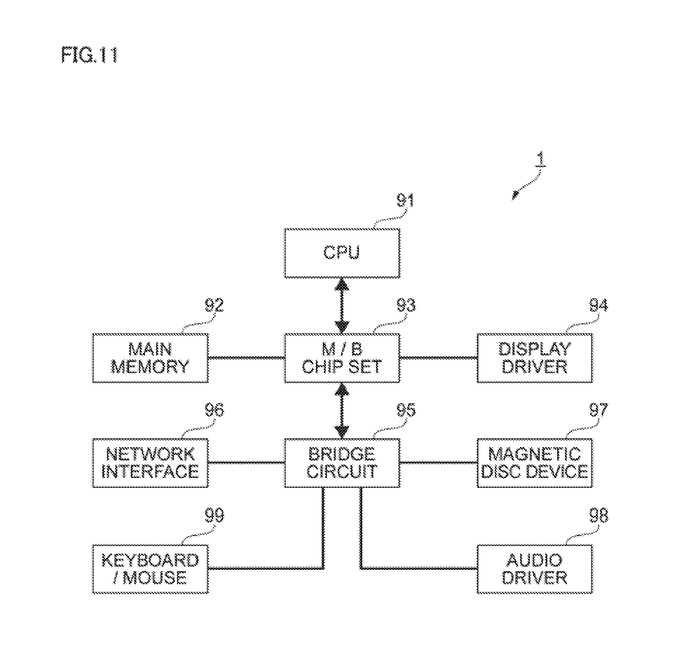

Referring to FIG. 11, there is shown an example of a hardware configuration of the workflow generating device 1 in the exemplary embodiments. As shown in the figure, the workflow generating device 1 may include a central processing unit (CPU) 91 serving as one example of a processor, a main memory 92 connected to the CPU 91 via a motherboard (M/B) chip set 93 and serving as one example of a memory, and a display driver 94 connected to the CPU 91 via the same M/B chip set 93. A network interface 96, a magnetic disk device 97, an audio driver 98, and a keyboard/mouse 99 are also connected to the M/B chip set 93 via a bridge circuit 95.

In FIG. 11, the various configurational elements are connected via buses. For example, the CPU 91 and the M/B chip set 93, and the M/B chip set 93 and the main memory 92 are connected via CPU buses, respectively. Also, the M/B chip set 93 and the display driver 94 may be connected via an accelerated graphics port (AGP). However, when the display driver 94 includes a PCI express-compatible video card, the M/B chip set 93 and the video card are connected via a PCI express (PCIe) bus. Also, when the network interface 96 is connected to the bridge circuit 95, a PCI Express may be used for the connection, for example. For connecting the magnetic disk device 97 to the bridge circuit 95, a serial AT attachment (ATA), a parallel-transmission ATA, or peripheral components interconnect (PCI) may be used. For connecting the keyboard/mouse 99 to the bridge circuit 95, a universal serial bus (USB) may be used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for supporting analysis based on a workflow, the method comprising:
obtaining a non-timeline-based workflow including a first process and a second process that is executed after the first process; and
outputting a timeline-based workflow including the first process arranged at a first position corresponding to a first time and the second process arranged at a second position corresponding to a second time after the first time.

2. The method of claim 1, wherein the second time is apart from the first time by an interval depending on a maximum number of processes from the first process to the second process.

3. The method of claim 1, wherein:
the non-timeline-based workflow further includes a third process that is a destination of return after the second process and that is executed before the first process, and
the timeline-based workflow further includes the third process arranged at a third position corresponding to a third time which is a time point from the first time to the second time.

4. The method of claim 1, wherein:
the first process and the second process are executed manually,
the non-timeline-based workflow includes a fourth process that is executed automatically after the first process and before the second process,
the first time and the second time is along a timeline for manual processes, and
the timeline-based workflow includes the fourth process arranged at a fourth position corresponding to a fourth time along a timeline for automatic processes that are executed after the first time and before the second time.

5. The method of claim 1, wherein:
the first process and the second process are executed manually,
a specific process of the first process and the second process is represented by a container-shaped display object designed after a fluid container and an accumulated fluid in the fluid container, and
a flow between the first process and the second process is represented by a channel-shaped display object designed after a fluid channel and a running fluid through the fluid channel.

6. The method of claim 5, wherein at least one of the container-shaped display object and the channel-shaped display object has an attribute indicating at least one of execution states of tasks accumulated in the specific process, a difficulty level of the specific process, human resources allocated to the specific process, and an operation state of the specific process.

7. The method of claim 1, wherein the timeline-based workflow is separated into a plurality of lanes, each of the plurality of lanes including at least one process and corresponding to at least one worker to execute the at least one process.

8. The method of claim 7, wherein each of the plurality of lanes has an attribute indicating a busyness level of the at least one worker.

9. An apparatus for supporting analysis based on a workflow, the apparatus comprising:
a processor; and
a memory coupled to the processor, wherein the memory comprises program instructions executable by the processor to cause the processor to:
obtain a non-timeline-based workflow including a first process and a second process that is executed after the first process; and
output a timeline-based workflow including the first process arranged at a first position corresponding to a first time and the second process arranged at a second position corresponding to a second time after the first time.

10. The apparatus of claim 9, wherein the second time is apart from the first time by an interval depending on a maximum number of processes from the first process to the second process.

11. The apparatus of claim 9, wherein:
the non-timeline-based workflow further includes a third process that is a destination of return after the second process and that is executed before the first process, and
the timeline-based workflow further includes the third process arranged at a third position corresponding to a third time which is a time point from the first time to the second time.

12. The apparatus of claim 9, wherein:
the first process and the second process are executed manually,
the non-timeline-based workflow includes a fourth process that is executed automatically after the first process and before the second process,
the first time and the second time is along a timeline for manual processes, and
the timeline-based workflow includes the fourth process arranged at a fourth position corresponding to a fourth time along a timeline for automatic processes that are executed after the first time and before the second time.

13. The apparatus of claim 9, wherein:
the first process and the second process are executed manually,
a specific process of the first process and the second process is represented by a container-shaped display object designed after a fluid container and an accumulated fluid in the fluid container, and
a flow between the first process and the second process is represented by a channel-shaped display object designed after a fluid channel and a running fluid through the fluid channel.

14. The apparatus of claim 13, wherein at least one of the container-shaped display object and the channel-shaped display object has an attribute indicating at least one of execution states of tasks accumulated in the specific process, a difficulty level of the specific process, human resources allocated to the specific process, and an operation state of the specific process.

15. The apparatus of claim 9, wherein the timeline-based workflow is separated into a plurality of lanes, each of the plurality of lanes including at least one process and corresponding to at least one worker to execute the at least one process.

16. The apparatus of claim 15, wherein each of the plurality of lanes has an attribute indicating a busyness level of the at least one worker.

17. A computer program product for supporting analysis based on a workflow, the computer program product comprising a computer readable storage medium having program instructions embodied therewith, the program instructions executable by a computer to cause the computer to:
obtain a non-timeline-based workflow including a first process and a second process that is executed after the first process; and
output a timeline-based workflow including the first process arranged at a first position corresponding to a first time and the second process arranged at a second position corresponding to a second time after the first time.

18. The computer program product of claim 17, wherein the second time is apart from the first time by an interval depending on a maximum number of processes from the first process to the second process.

19. The computer program product of claim 17, wherein:
the non-timeline-based workflow further includes a third process that is a destination of return after the second process and that is executed before the first process, and
the timeline-based workflow further includes the third process arranged at a third position corresponding to a third time which is a time point from the first time to the second time.

20. The computer program product of claim 17, wherein:
the first process and the second process are executed manually,
the non-timeline-based workflow includes a fourth process that is executed automatically after the first process and before the second process,
the first time and the second time is along a timeline for manual processes, and
the timeline-based workflow includes the fourth process arranged at a fourth position corresponding to a fourth time along a timeline for automatic processes that are executed after the first time and before the second time.
